(19) United States
(12) Patent Application Publication
(10) Pub. No.: US 2011/0165543 A1
(43) Pub. Date: Jul. 7, 2011

(54) DIAPER WITH GRAPHIC ILLUSTRATION/TEXT/IMAGE DIRECTED TO PARENTS/CAREGIVERS BASED ON THE DEVELOPMENTAL STAGE OF THE INFANT, TODDLER OR CHILD

(76) Inventor: Shulamit N. Ritblatt, Poway, CA (US)

(21) Appl. No.: 12/834,213

(22) Filed: Jul. 12, 2010

Related U.S. Application Data
(60) Provisional application No. 61/227,779, filed on Jul. 22, 2009.

(51) Int. Cl. G09B 19/00

(52) U.S. Cl. 434/236

(57) ABSTRACT

At the beginning of life, parent-infant interactions are the building blocks of the baby's brain and socio-emotional and cognitive development. Eye contact, touch, facial expressions, and verbal communications are essential ingredients in these interactions. One of the most prominent activities a parent/caregiver is involved in during the first year of life is diaper changing. For a newborn, the frequency of diaper changing can reach 10-12 times a day. Diaper changing brings the opportunity for this parent-child interaction to take place. The present invention uses diapers as a medium and/or tool to deliver educations and developmental images. Information and/or written and/or visual messages and tips to the parents/caregivers of infants, toddlers and children.

### RELATED APPLICATIONS

This application claims priority from U.S. Provisional Application No. 61/227,779, filed on Jul. 22, 2009, the contents of which are hereby incorporated by reference herein.

### TECHNICAL FIELD OF THE INVENTION

The invention relates generally to diapers. More specifically, there is a graphic illustration/text/image printed on the diaper that is visible to the parent/caregiver during the diaper changing process in the form of a message or image which provides educational and developmental images and/or written and/or visual information, messages, and tips for parents/caregivers of infants, toddlers and children.

### BACKGROUND OF THE INVENTION

At the beginning of life, parent-infant interactions are the building blocks of the baby's brain and socio-emotional and cognitive development. Eye contact, touch, facial expressions and verbal communication are essential ingredients in these interactions. Early positive or negative interpersonal interactions affect the developing brain's structure and its organization (Schore, 2001). Schore (2001) argues that the young infant relies on his/her emotional experiences to “evaluate on a moment-to-moment basis stressful changes in the external environment, especially the social environment.” Positive interactions with the parent encourage the child to communicate.

Based on Bowlby's Attachment Theory (1969), positive relationships with the caregiver help regulate the emotional arousal levels of the young child, resulting in secure attachment. Mothers who are available and responsive to their infant's needs establish a sense of security that the infant comes to rely on. Young children need to develop a relationship with at least one primary caregiver for social and emotional development to occur normally.

Infants form attachment to any consistent caregiver who is sensitive and responsive in social interactions with them. The quality of the interaction is more influential than the amount of time spent. The biological mother is the usual principal attachment figure but the role can be taken by anyone who consistently behaves in a “mothering” way over a period of time, and there is nothing to suggest that fathers are not equally likely to become principal attachment figures if they provide most of the child care and related social interactions.

Early experiences with caregivers gradually give rise to a system of thoughts, memories, beliefs, expectations, emotions and behaviors about the self and others. This system called the “internal working model of social relationships” continues to develop with time and experience. The attachment behavioral system develops in stages as the child grows and interacts with the caregiver. Pre-attachment behaviors occur in the first six months of life when the infants' behavior is oriented to attract the attention of any caregiver in the vicinity. Clear-cut attachment develops between the ages of six months and two years. The infant's behavior towards the caregiver becomes organized on a goal-directed basis to achieve the conditions that make it feel secure. Infant's that develop a secure attachment pattern use their caregiver as a secure base for exploration while insecure attachment patterns can compromise exploration and the achievement of self-confidence. A securely attached baby is free to concentrate on exploring and learning from his environment (Bowlby, 1969).

One of the most prominent activities a parent/caregiver is involved in during the first year of life is diaper changing. For a newborn, the frequency of diaper changing can reach 10-12 times a day. Diaper changing brings the opportunity for the parent/infant interaction to take place especially when the newborn's vision during the first three months is only 8-10 inches.

The combination of low cost and ease of use have made disposable diapers the primary choice for parents and other child care providers. Disposable diapers come in every imaginable shape and size, and are typically purchased based on cost, size, absorbency and aesthetic appearance. Some disposable diapers include graphics that are designed to amuse children.

U.S. Pat. No. 4,249,532 issued to Polansky et al. on Feb. 10, 1981 describes a disposable diaper having a decorative design thereon so to be more attractive in appearance and handling.

U.S. Pat. No. 6,297,424 issued to Olson et al. on Oct. 2, 2001 describes a disposable absorbent article such as a training pant which includes wetness indicating graphics that provide an interactive training guide to enhance the toilet training process. Olson describes an interactive graphic which includes a permanent character graphic and one or more active object graphic, which “appears” or “disappears” from view in response to exposure to urine or the environment thus allowing the caregiver to encourage the child to refrain from going potty in their training pants or the active graphic will disappear.

U.S. Patent Publication No. 2006/0135925 by Hurley et al. on Jun. 22, 2006 describes a system that includes a package and a plurality of diapers within the package and further includes an appliqué that is adapted to be detachably adhered to each of the plurality of diapers in the system. Hurley describes an appliqué that may initially be placed on one of the diapers and when the original diapers is discarded, the appliqué may then be transferred to another newly worn diaper in order to promote interaction between a child and the diapers that are used during multiple diaper changes.

U.S. Pat. No. 7,553,301 issued to Suzuki et al. on Jun. 30, 2009 describes a method for determining an illustration to be displayed on a diaper worn by an infant for the purpose of arousing the interest of the infant in order to alleviate both the mental and physical burden of a struggling infant for the diaper changer. Suzuki describes a method where the illustration is determined based on the age in months of the infant since whether the illustration will arouse the interest of the infant depends on his/her age in months.

One drawback associated with the aforementioned diapers is that graphics printed on the diapers are meant to grab the attention of the infant and amuse them during the diaper changing process. To the best of our knowledge, no diaper currently exists that takes advantage of the frequency of diaper changing and provides a tool for enhancing the parent-child interaction using the presentation of valuable information for the parent/caregiver directly on the diaper.

### SUMMARY OF THE INVENTION

The present invention relates to diapers as a medium and tool to deliver educational and developmental messages, information, and tips for parents/caregivers of infants, toddlers and children. The graphic illustration/text/image (written or printed in images) may include, but is not limited to, information and tips on developmental milestones, health and nutrition, parent-child interactions, warning signs, immunization, discipline, play, appropriate toys, and safety.

Often diaper's size, which is determined by baby's weight, coincides with the chronological age of the baby and hence can relate to the developmental stage of the infant. The graphic illustration/text/image will match the developmental age of the infant and may be determined by the diaper's size. The graphics may be placed in any location on the diaper that is suitable for the text or images to be exposed to the parent/caregiver during the diaper changing process.

### BRIEF DESCRIPTION OF THE DRAWINGS

FIG. 1 illustrates a front perspective view of a diaper incorporating the principles of the present invention.

FIG. 2 illustrates a rear perspective view of the diaper of FIG. 1.

FIG. 3 illustrates a side perspective view of the diaper of FIGS. 1 and 2.

FIG. 4 illustrates a top perspective view of the diaper of FIGS. 1 and 2, in a stretched and laid flat condition for purposes of illustration.

### DETAILED DESCRIPTION OF THE INVENTION

### Definitions

“Graphic illustration/text/image” as used herein refers to the message and/or image that is visible to the parent/caregiver which provides educational and developmental images and/or written and/or visual information, messages and tips for parents/caregivers of infants, toddlers and children.

“Parent/caregiver” as used herein refers to any individual who provides the majority of the child care and social interactions with the infant, toddler or child.

“Developmental stages” as used herein refers to the biological and psychological changes that occur in human beings between birth and the end of adolescence, as the individual progresses from dependency to increasing autonomy.

“Educational and developmental messages” as used herein refers to graphic illustrations/text in the form of messages and tips for parents/caregivers of infants, toddlers and children. The graphic illustration/text/image (written or printed in images) may include, but is not limited to, information and tips on developmental milestones, health and nutrition, parent-child interactions, warning signs, immunization, discipline, play, appropriate toys, and safety.

“Fastener” as used herein refers to the tabs on the diaper that fix the back portion of the diaper to the front portion of the diaper and secure the diaper on the infant; toddler or child wearing the diaper.

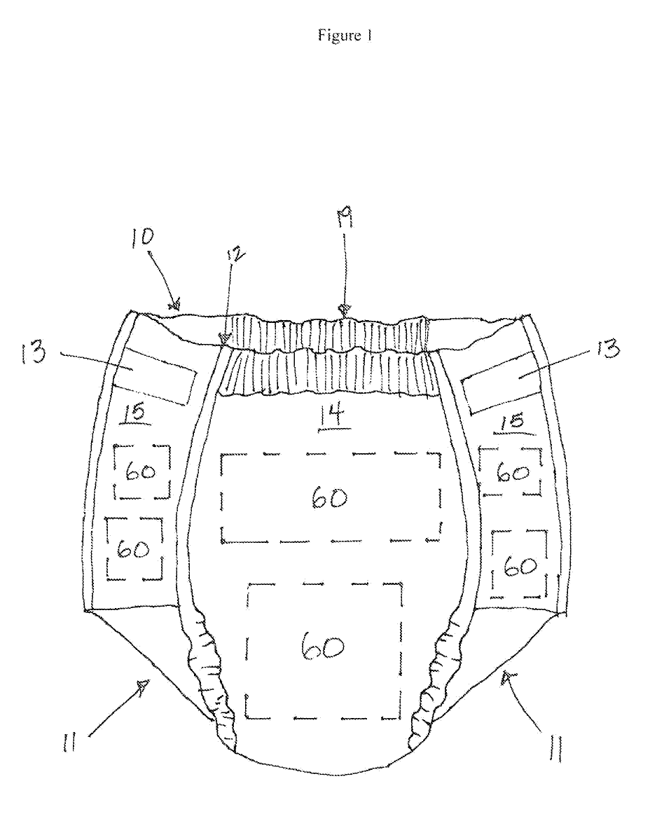

A diaper 10 is illustrated in a frontal fully assembled condition in FIG. 1. The diaper 10 comprises a first or front waist region 12, a second or back waist region 19 and a front panel 14 which creates a crotch region and two leg openings 11 while connecting the front waist region 12 and the back waist region 19. The diaper 10 further comprises a frontal side panel 15 where the closed fasteners 13 secure the back waist region 19 to the front waist region 12. The diaper 10 further comprises a frontal graphic illustration/text/image display panel 14 which is suitable for the placement the graphical illustration/text/image 60 or multiple graphical illustration/text/images 60. Placement of the graphical illustration/text/image 60 may also be located on the frontal side panel 15. The graphical illustration/text/image 60 may be in any suitable orientation and quantity on the frontal display panel 14 and the frontal side panel 15.

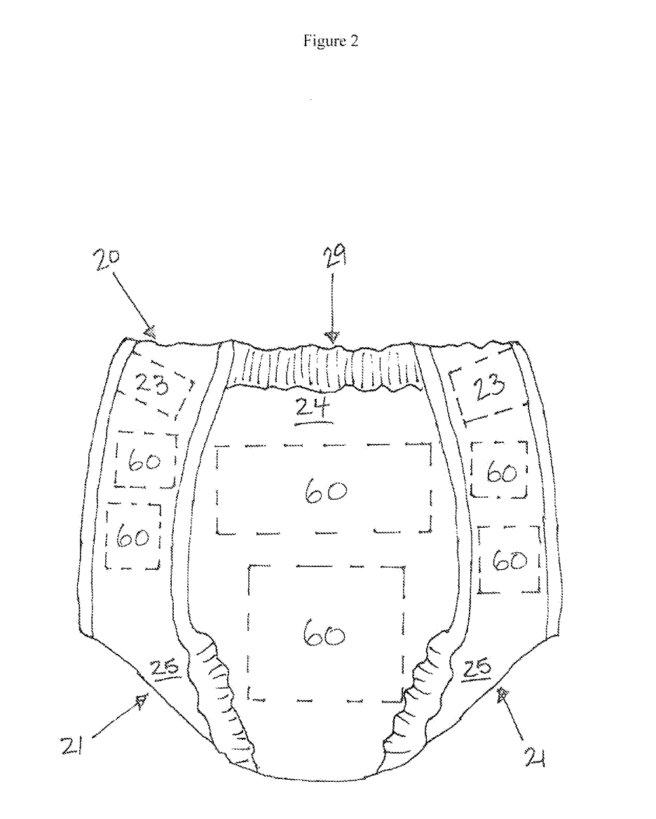

A diaper 20 is illustrated in a back fully assembled condition in FIG. 2. The diaper 20 comprises a back waist region 29 and a back panel 24 which connects to a front panel 14 (FIG. 1) creating a crotch region and two leg openings 21. The diaper 20 further comprises a back side panel 25 where the closed fasteners 23 secure the back waist region 29 to the front waist region 12. The diaper 20 further comprises a back graphic illustration/text/image display panel 24 which is suitable for the placement the graphical illustration/text/image 60 or multiple graphical illustration/text/images 60. Placement of the graphical illustration/text/image 60 may also be located on the back side panel 25. The graphical illustration/text/image 60 may be in any suitable orientation and quantity on the back display panel 24 and the back side panel 25.

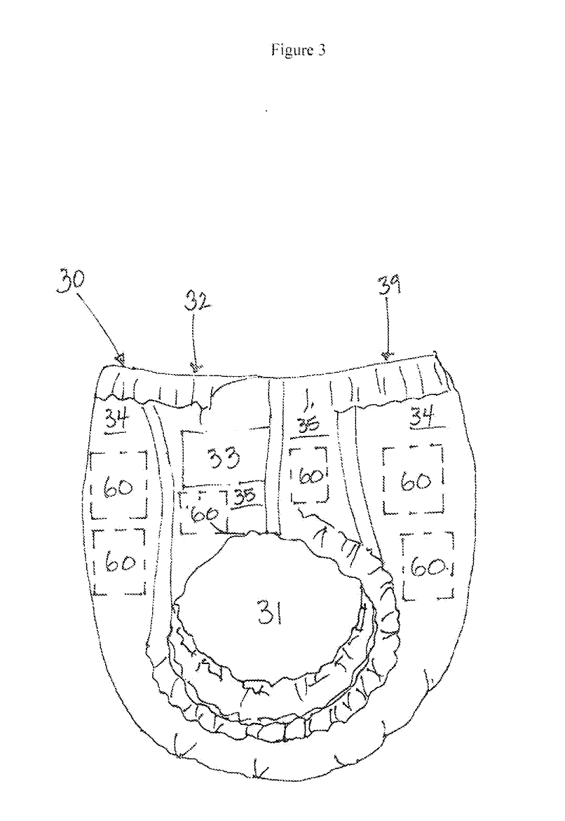

A diaper 30 is illustrated in a side fully assembled condition in FIG. 3. The diaper 30 comprises a front waist region 32, a back waist region 39 and a front panel 34 which creates a crotch region and leg opening 31 while connecting the front waist region 32 and the back waist region 39. The diaper 30 further comprises a side panel 35 where the closed fastener 33 secures the back waist region 39 to the front waist region 32. The diaper 30 further comprises a front/back graphic illustration/text/image display panel 34 which is suitable for the placement the graphical illustration/text/image 60 or multiple graphical illustration/text/images 60. Placement of the graphical illustration/text/image 60 may also be located on the side panel 35. The graphical illustration/text/image 60 may be in any suitable orientation and quantity on the front/back display panel 34 and the side panel 35.

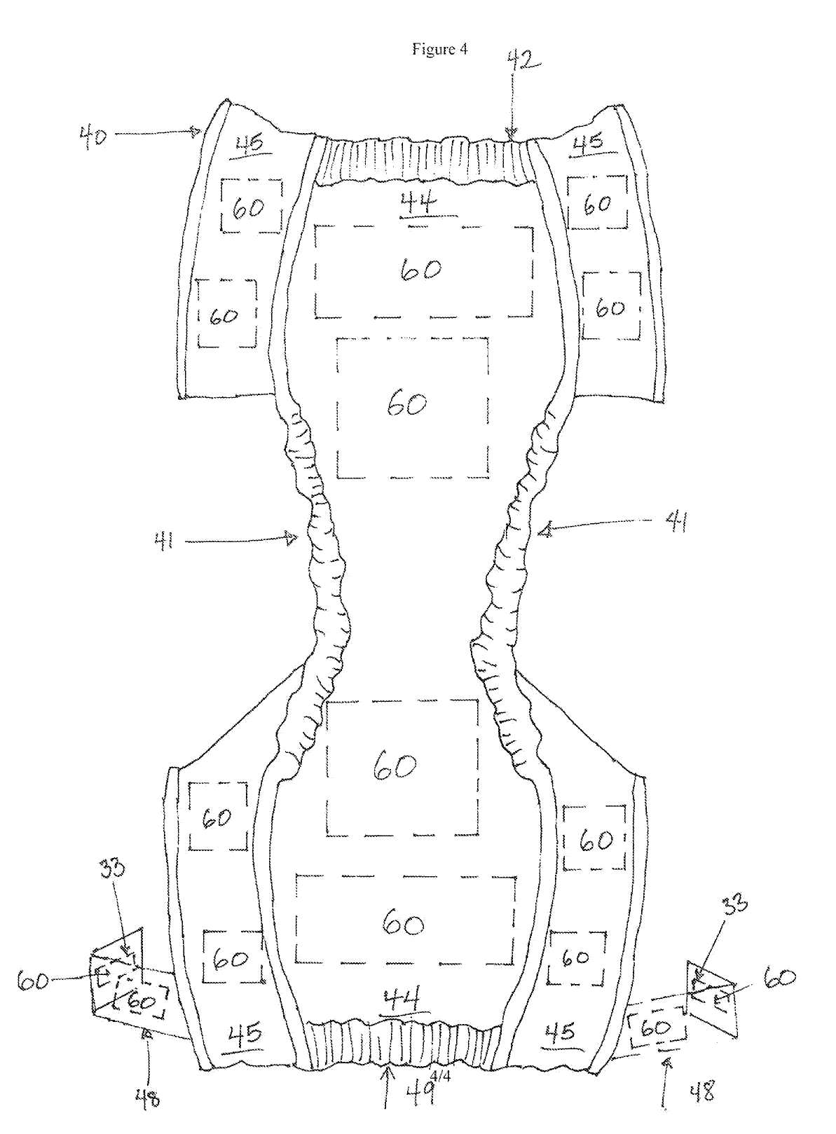

A diaper 40 is illustrated in a partially disassembled, stretched and laid flat condition in FIG. 4. The diaper 40 comprises a front waist region 42, a back waist region 49 and a front panel 44 which extends between the front waist region 42 and the back waist region 49 to create a crotch region and two leg openings 41. The diaper 40 further comprises four side panels 45 with the two side panels connected to the back waist region 49 having an open fastener 48 attached to each side panel. Each open fastener 48 may contain a graphic illustration/text/image 60 in the form of a question and answer with the question 60 being displayed on the closed fastener 33 and the answer 60 being displayed on the open fastener. The diaper 40 further comprises a front/back graphic illustration/text/image display panel 44 which is suitable for the placement the graphical illustration/text/image 60 or multiple graphical illustration/text/images 60. Placement of the graphical illustration/text/image 60 may also be located on the side panels 45. The graphical illustration/text/image 60 may be in any suitable orientation and quantity on the front/back display panel 44 and the side panels 45.

One embodiment of the present invention provides a diaper that serves the traditional functions of a diaper while delivering educational and developmental messages and tips for parents/caregivers of infants, toddlers and children.

In another embodiment of the present invention, the graphic illustration/text/image may be in the form of a written message.

In another embodiment of the present invention, the graphic illustration/text/image may be in the form of printed images.

In another embodiment of the present invention, the graphic illustration/text/image may be determined by the diaper's size which typically coincides with the infant's chronological age and developmental stage.

In another embodiment of the present invention, the graphic illustration/text/image may be displayed on any appropriate location on the diaper, including but not limited to, the front, back, sides, diaper fasteners or any location that is visible and suitable for the text or images to be exposed when the parent/caregiver removes the stickers from both sides in order to fasten it.

In another embodiment of the present invention, the graphic illustration/text/image may be displayed on the diaper fasteners in the form of a question and answer such that the question is displayed on the closed fastener and the answer is displayed on the opened fastener.

In another embodiment of the present invention, the graphic illustration/text/image may be information or parenting tips regarding child development and/or developmental milestones as well as developmental delays.

In another embodiment of the present invention, the graphic illustration/text/image may be information or parenting tips regarding health and nutrition for both the infant and the mother.

In another embodiment of the present invention, the graphic illustration/text/image may be information or parenting tips regarding parent-child interaction.

In another embodiment of the present invention, the graphic illustration/text/image may be information or parenting tips regarding warning signs, immunization and safety alerts.

In another embodiment of the present invention, the graphic illustration/text/image may be information or parenting tips regarding discipline, play, sibling rivalry and appropriate toys.

In another embodiment of the present invention, the graphic illustration/text/image may be information regarding the parent's wellbeing, community resources and help-lines.

In another embodiment of the present invention, the graphic illustration/text/image may be information to parents/caregivers regarding recent research findings relevant to young children's growth and development or any other applicable or relevant information.

In another embodiment of the present invention, the graphic illustration/text/image may be information or parenting tips regarding advice and suggestions for handling various situations, including but not limited to, diaper rash, the signs of post-partum depression, recommended remedies, etc.

In another embodiment of the present invention, the graphic illustration/text/image may be written in different languages to provide the parent/caregiver with the information in their own native language, or alternatively, the graphic illustration/text/image may be written in more than one language on the same diaper.

In another embodiment of the present invention, the graphic illustration/text/image may be categorized by diaper size which corresponds to infant weight, e.g. newborn: up to 10 lbs; Size 1: 8-14 lbs: Size 2: 12-18 lbs; Size 3: 16-28 lbs; Size 4: 22-37 lbs; Size 5: 27+lbs; and Size 6: 35+lbs.

In another embodiment of the present invention, the graphic illustration/text/image may correspond to the newborn size, e.g. “Please come closer. I can see up to 8-10 inches only;” “I like to hear your voice; I recognize it from before I was born;” “Any time you take me in the car, please put me in a car safety seat;” “Mom, when you feel “blue” please talk about your feelings with others;” and “Breast milk is the perfect food for my health.”

In another embodiment of the present invention, the graphic illustration/text/text may correspond to Size 1, e.g. “Call my pediatrician and schedule my first appointment;” “Please put me on my back when I am ready to sleep;” “Do you know that babies that sleep on their back are less likely to die from SIDS?” “Crying is a way I use to communicate my needs;” and “I like when you hold me gently and very close.”

In another embodiment of the present invention, the graphic illustration/text/image may correspond to Size 2, e.g. “Sucking on things gives me pleasure;” “Lay me on my tummy when I am awake so I develop my upper torso;” “I turn my head towards you when you talk to me;” “Mom, take time for yourself, start exercising;” and “I love when you are taking me in a stroller to walk with you outside.”

In another embodiment of the present invention, the graphic illustration/text/image may correspond to Size 3. e.g. “When you take care of me daily, I feel safe and secure;” “Paying attention to me does not spoil me;” “I love to play on the floor with my toys;” “Please learn how I respond and what are my needs;” and “The way you treat me affects how I feel about myself”

In another embodiment of the present invention, the graphic illustration/text/image may correspond to Size 4. e.g. “The things you do with me help me learn;” “All the things that you do with me helps my brain develop;” “I look at you when I am uncertain or afraid;” “Don't leave me alone in the bath or a pool;” and “Encourage me when I master a task; I enjoy when you clap and praise me.”

In another embodiment of the present invention, the graphic illustration/text/image may correspond to Size 5, e.g. “1 love to have routines;” “Let me use the hand I prefer using;” “Let me practice life skills and help with dressing and undressing;” “I love to listen to you reading to me and pointing to the pictures in the book;” and “Please do not feed me sweets and fatty foods.”

In another embodiment of the present invention, the graphic illustration/text/image may correspond to Size 6, e.g. “It is important to watch that I meet the developmental milestones;” “Play is the way I learn about the world and understand it;” “Teach me to use words to describe the way I feel;” “Support my behavior by setting limits and providing clear expectations;” and “You are my first teacher; I follow your example.”

It will be appreciated that details of the foregoing embodiments, given for purposes of illustration, are not to be construed as limiting the scope of this invention. Although several embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention, which is defined in the following claims and all equivalents thereto. Further, it is recognized that many embodiments may be conceived that do not achieve all of the advantages of some embodiments, particularly of the preferred embodiments, yet the absence of a particular advantage shall not be construed to necessarily mean that such an embodiment is outside the scope of the present invention.

What is claimed is:

1. A diaper comprising a graphic illustration/text/image wherein the graphic illustration/text/image is printed on the diaper such that it is visible to the parent/caregiver during the diaper changing process and provides educational and developmental tips for parents/caregivers of infants, toddlers and children.

2. The diaper of claim 1 wherein the graphic illustration/text/image comprises at least one written message.

3. The diaper of claim 1 wherein the graphic illustration/text/image comprises at least one printed image.

4. The diaper of claim 1 wherein the graphic illustration/text/image is displayed on any appropriate location on the diaper, including but not limited to, the front, back, sides, diaper fasteners or any location that is visible and suitable for the text or images to be exposed when the parent/caregiver removes the stickers from both sides in order to fasten it.

5. The diaper of claim 4 wherein the graphic illustration/text/image is displayed on the fastener and presented in the form of a question and answer such that the question is displayed on the closed fastener and the answer is displayed on the opened fastener.

6. The diaper of claim 1 wherein the graphic illustration/text/image comprises information or parenting tips regarding child development and/or developmental milestones.

7. The diaper of claim 1 wherein the graphic illustration/text/image comprises information or parenting tips regarding the health and nutrition of both the infant and the mother.

8. The diaper of claim 1 wherein the graphic illustration/text/image comprises information or parenting tips regarding parent-child interaction.

9. The diaper of claim 1 wherein the graphic illustration/text/image comprises information or parenting tips regarding warning signs, immunization and safety alerts.

10. The diaper of claim 1 wherein the graphic illustration/text/image comprises information or parenting tips regarding discipline, play and appropriate toys.

11. The diaper of claim 1 wherein the graphic illustration/text/image comprises information regarding the parent's wellbeing, community resources and help-lines.

12. The diaper of claim 1 wherein the graphic illustration/text/image comprises information to parents/caregivers regarding recent research findings relevant to young children's growth and development or any other applicable or relevant information.

13. The diaper of claim 1 wherein the graphic illustration/text/image comprises information or parenting tips regarding advice and suggestions for handling various situations, including but not limited to, diaper rash, the signs of post-partum depression, recommended remedies, etc.

14. The diaper of claim 1 wherein the graphic illustration/text/image comprises messages or printed images in at least two different languages to provide the parent/caregiver with the information in their own native language.

15. The diaper of claim 1 wherein the graphic illustration/text/image is categorized by diaper size which corresponds to infant weight, e.g. newborn: up to 10 lbs; Size 1: 8-14 lbs; Size 2: 12-18 lbs; Size 3: 16-28 lbs; Size 4: 22-37 lbs; Size 5: 27+lbs; and Size 6: 35+lbs.

16. The diaper of claim 15 wherein the graphic illustration/text/image comprises information corresponding to the newborn size, e.g. “Please come closer, I can see up to 8-10 inches only;” “I like to hear your voice; I recognize it from before I was born;” “Any time you take me in the car, please put me in a car safety seat;” “Mom, when you feel “blue” please talk about your feelings with others;” and “Breast milk is the perfect food for my health.”

17. The diaper of claim 15 wherein the graphic illustration/text/image comprises information corresponding to Size 1, e.g. “Call my pediatrician and schedule my first appointment;” “Please put me on my back when I am ready to sleep;” “Do you know that babies that sleep on their back are less likely to die from SIDS?” “Crying is a way I use to communicate my needs;” and “I like when you hold me gently and very close.”

18. The diaper of claim 15 wherein the graphic illustration/text/image comprises information corresponding to Size 2, e.g. “Sucking on things gives me pleasure;” “Lay me on my tummy when I am awake so I develop my upper torso;” “I turn my head towards you when you talk to me;” “Mom, take time for yourself, start exercising;” and “I love when you are taking me in a stroller to walk with you outside.”

19. The diaper of claim 15 wherein the graphic illustration/text/image comprises information corresponding to Size 3, e.g. “When you take care of me daily. I feel safe and secure;” “Paying attention to me does not spoil me;” “I love to play on the floor with my toys;” “Please learn how I respond and what are my needs;” and “The way you treat me affects how I feel about myself.”

20. The diaper of claim 15 wherein the graphic illustration/text/image comprises information corresponding to Size 4, e.g. “The things you do with me help me learn;” “All the things that you do with me helps my brain develop;” “I look at you when I am uncertain or afraid;” “Don't leave me alone in the bath or a pool;” and “Encourage me when I master a task; I enjoy when you clap and praise me.”

21. The diaper of claim 15 wherein the graphic illustration/text/image comprises information corresponding to Size 5, e.g. “I love to have routines;” “Let me use the hand I prefer using:” “Let me practice life skills and help with dressing and undressing;” “I love to listen to you reading to me and pointing to the pictures in the book;” and “Please do not feed me sweets and fatty foods.”

22. The diaper of claim 15 wherein the graphic illustration/text/image comprises information corresponding to Size 6, e.g. “It is important to watch that I meet the developmental milestones;” “Play is the way I learn about the world and understand it;” “Teach me to use words to describe the way I feel;” “Support my behavior by setting limits and providing clear expectations;” and “You are my first teacher; I follow your example.”
